(19) United States
(12) Patent Application Publication
(10) Pub. No.: US 2006/0198972 A1
(43) Pub. Date: Sep. 7, 2006

(54) Disposable Paper Eating Utensils for Catering Service

(75) Inventors: Takashi Ueda, Higashiosaka-shi (JP); Hideyuki Ueda, Higashiosaka-shi (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: KABUSHIKI KAISHA SHUEI, Higashiosaka-shi (JP)

(21) Appl. No.: 11/306,116

(22) Filed: Dec. 16, 2005

(30) Foreign Application Priority Data
Jun. 16, 2003 (JP) 2003-170763
Feb. 3, 2004 (JP) 2004-027069

(51) Int. Cl. B32B 27/32

(52) U.S. Cl. 428/35.2; 428/182

(57) ABSTRACT

Disposable paper eating utensil enabling most of the utensil-constituent paper to be recycled. A blank composed of at least one thin ply laminated onto a thick ply is inserted between the core and cavity of a compression mold and molded into the utensil. The molding process clenches corrugations produced in the thin ply into corrugated portions of the thick ply, produced in the rising sidewall surfaces of the utensil, yielding a paper eating utensil of not readily separable two-ply construction. The eating utensil thus obtained can contain foodstuffs bearing liquid condiments, and after the utensil has been used the thin ply can be separated from the thick ply and disposed of as soiled waste, while the thick ply portion discarded as recyclable waste.

### BACKGROUND OF THE INVENTION

1. Technical Field

The present invention relates to disposable paper-made eating utensils (plate, tray, or tray type packet) that are ideal for use at buffet type dinner parties and various types of event sites, blanks for producing the utensils, and molding presses for producing the utensils.

2. Description of the Related Art

Conventionally, disposable or “oven-to-table” vessels (or tableware) such as cups and plates made of paper and plastic are often used at simple stand-up parties, religious festivals, and outdoor gatherings.

One common method of fabricating such paper-made eating utensils involves cutting an original sheet of paper to dimensions slightly larger than the overall contour of the vessel to produce blanks, and then inserting these blanks one sheet at a time into a cavity mold and compressing them with a core mold to shape a mold object. To give the vessel strength and water resistance, in this case a relatively thick, high-quality cardboard paper whose surface has been coated by a waterproofing agent is used.

As for materials for plied papers in this invention, two sorts of papers are required. One is a sort of cellulose paper commercially available as cardboard paper, corrugated board paper or those provided with self-standing or self-support property durable to form a vessel. The other is a sort of cellulose paper or plastic film such as clear thin plastic film made of polyethylene or polypropylene, water-proof cellulose paper, other chemically treated cellulose paper/plastic film or those provided with non-self standing or non-self support property, which lack the durability to form a vessel.

Japanese Unexamined Pat. App. Pub. No. 2002-53121 discloses paper tableware as a one-way tray obtained by adhering layers of paper and resin film together with an adhesive, stamping this laminate into a blank form, and then applying heat and pressure, although its intended purpose of use is different.

In addition, Japanese Unexamined Pat. App. Pub. No. JP 2001-328622 discloses paper tableware formed by folding in which a stain-proof film is pasted to the inner surface of the paper vessel with an adhesive.

The publication entitled “Plastics Molding,” authored by John Delmonte, published by John Wiley & Sons, Inc. in 1952 is hereby incorporated herein by reference.

Food items are placed on the paper vessels or the like manufactured as above and then these food items are consumed, after which the paper vessels are discarded with liquid such as condiments and seasoning liquids still adhered to them. Even if such dirtied paper vessels are recovered, it is nearly impossible to use them as recycled paper, and thus the only option is to burn them. It was only natural that such paper vessels would be frowned upon as a waste both of high quality paper and our natural resources. One approach to solving this problem is presented in the above-cited Japanese Pat. App. Pub. No. 2002-53121. In this case, the vessel is made by adhering layers of upper vessels made of thin paper to a main unit made of thick paper, and after eating, the thin-paper vessel on the inside surface that has become dirty is peeled away and can be discarded separate from the main vessel unit, which has not become dirty, and therefore the main vessel unit, which is made of high-quality paper, can be recycled. This method requires the addition of a manufacturing process of pasting a film to the vessel unit with adhesive to keep the vessel from becoming dirty, and thus not only is this vessel more expensive but the section of the molded vessel where the adhesive agent is applied may change in color, and this may give the impression of uncleanness to the user.

### BRIEF SUMMARY OF THE INVENTION

A first aspect of this invention will be described with reference to FIGS. 1 through 4, and this illustration is concerned with a paper-made plate whose manufacture includes a step of providing a blank or plied papers formed of a cardboard paper overlapped with one or plural thin papers, followed by a second step of the compression molding. As is known, the blank is set into a cavity (or interspace) between a pair of a convex (or core) and a concave (or cavity) mold. Therein, the heat and press will force plied papers to be impacted into wrinkle (corrugation) troughs which run through thickness of the cardboard wherein entangled thin ply (or plies) will undergo compaction by two trough sides to result in being nipped status enough to cause the entanglements to resist probable finger manipulations which will occur when the plate is put into service.

Consequently, respective plies are provided with linkage sufficient to serve as a substantially integrated eating utensil. Thus, when put into service, contaminations caused by dished up foods will be limited on an upper most ply paper which has directly been exposed to the stay of foods. Thus, peeling such paper off will renew a fresh paper surface in turn. It brings about economies.

More detailed description concerning wrinkles noted above will be given in the descriptions on FIGS. 1 and 2 later, wherein “wrinkles” numbered 5 will be noted “parallel or centripetally converged wrinkles.” (However, in mentioning generally, thereafter it will often be simplified to “centripetally converged wrinkles” or “wrinkles.”)

In a second aspect of the invention, a plurality of projection-shaped ribs are formed in the bottom surface of a paper tray, in which two or more sheets of original paper (including plastic film) are layered on one another, and heated and compressed in order to mold them into one piece, such that the plurality of trays made of original paper engage one another at the rib portions of the bottom surface in addition to the wrinkle portions that occur from the rising side wall to the upper end edge portion. This allows the plurality of trays to feel more like a single tray when used, and allows them to be more easily separated.

In a third aspect of the invention, of the two or more sheets of original paper that constitute the blank, one sheet is thick paper, and the other is thin paper that is thinner than the thick paper, silicon-applied paper, plastic film, or biodegradable plastic resin film, one or more of the other sheet is/are layered on the thick sheet and the two are compression molded into a paper tray-type packet. The tray-type packets other than the packet made of thick paper are peeled off one by one over the course of a meal so that there is always a clean, water-resistant packet surface. By giving the outer (main unit) portion made of thick paper sufficient strength, it is possible for the paper tray-type packet to have a large number of thin paper tray-type packet layers.

In a fourth aspect of the invention, a main tray-type packet unit and a lid member that are connected by a hinge are molded into one piece using a blank that is obtained by stacking an inner blank made of thin paper on an outer blank in which one or more open windows have been formed, and the plurality of layered tray-type packets engage one another through vertical wrinkles that occur in the upper edge and in the side wall surface of the main unit and the lid member. By choosing a transparent or semi-transparent paper material as the thin paper, a tray-type packet with viewing ports whose inside can be viewed is achieved.

In a fifth aspect of the invention, a blank for molding the paper vessel made of thick paper is spot adhered to a front surface or a rear surface of an oblong thin paper that is intermittently inserted between a cavity and a core of a metal mold for molding a paper vessel. This configuration achieves the effect that the plurality of layered blanks do not shift with respect to one another, and since the thin paper is continuous paper, the vessel can be molded more efficiently.

In a sixth aspect of the invention, a vessel-shaped cavity with a rising side-wall surface is formed in the mold on one side of a metal mold, and a core that is symmetrical with respect to the cavity across a gap of two to three sheets of original paper is formed in the mold on the other side of the metal mold, and the cavity-side plate and the core-side plate abut one another about their circumference or tightly fit into one another in a manner that produces a shearing blade surface, at a portion of the cavity corresponding to its outer circumferential edge. By inserting the blank made of thick paper and thin paper into the metal mold and compression molding it, the edge portion of the paper vessel that is obtained is trimmed away as the vessel is molded.

As recited in the third and fourth aspects, raw papers include a single sheet of thick original paper while the other component is thin paper, silicon-applied paper, plastic film, or biodegradable resin film (hereinafter, these may be collectively referred to as thin paper), and the lowermost plied vessel is formed by the thick paper while the upper plied protective covering is formed by the other component such as thin paper. The upper covering made of the thin paper or the like will become dirty by condiments or seasoning liquid food items, but the lowermost vessel will not. Thus, at stand-up parties, for example, the thin paper vessel on the surface side that has become dirty can be peeled away one by one so that it is always possible to have a clean thin paper vessel for use, dirtied vessels and non-dirty vessels can be discarded separately, and the thick paper vessel can be used as a recyclable resource without it becoming dirty. Thus, regarding the function of each layer, the lowermost layer serves as a vessel while the upper layers other than the lowermost layer essentially serve as covers; in the following description, however, the layers other than the lowermost layer may be referred to as “vessels” for expressing the entirety as one piece.

If the above blanks that are cut from thick paper and thin paper in a predetermined shape are layered on and spot adhered to one another at a number of locations through ultrasound, for example, then the blanks can be prevented from shifting with respect to one another, which easily occurs when the blanks are inserted into the metal mold for compression molding, the vessels are kept from unnaturally peeling apart from one another or warping (or bulging upward) when used, and moreover, a vessel with a lid can be provided with windows that allow the inside of the vessel to be viewed when a transparent material is used as the thin paper.

The metal mold according to the sixth aspect has a shearing blade that trims the circumferential edge of the vessel as the vessel is molded, and thus if long continued or non-leaf cut raw papers in roll form, for example, is intermittently supplied into and molded, the time for the step of pre-cutting the blank is obviated and the production costs for the paper-made vessel are lowered.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1A is a plan view, and FIG. 1B is a cross section taken along the line A-B, of the vessel according to one embodiment of the invention;

FIG. 2A is a plan view, and FIG. 2B is a lateral surface view, of the circular blank made of thick paper;

FIG. 3 is a lateral surface view of a cross section of an illustrative metal mold for molding the paper vessel;

FIG. 4 is a cross-sectional view that schematically illustrates the wrinkles that occur in the paper vessel;

FIG. 5 is a plan view that illustrates an oblong blank made from thick paper;

FIG. 6 is a plan view that illustrates an oblong blank made from thin paper;

FIG. 7 is a perspective view illustrating the oblong vessel;

FIG. 8 is a perspective view of the vessel with lid;

FIG. 9 is a blank for the vessel with lid.

FIG. 10 illustrates how the thick paper and the thin paper that are layered on one another are adhered through ultrasound.

FIG. 11 is a lateral cross section showing a method for supplying the thin-paper side paper material into the metal mold as roll original paper, and adhering the thick-paper blank to this thin paper through ultrasound.

FIG. 12 is a lateral cross section showing how the paper material is supplied into the metal mold as roll original paper.

### DETAILED DESCRIPTION OF THE INVENTION

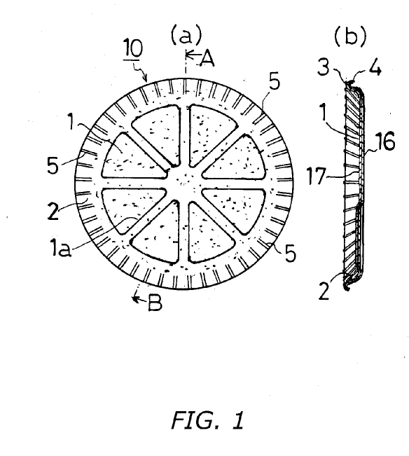

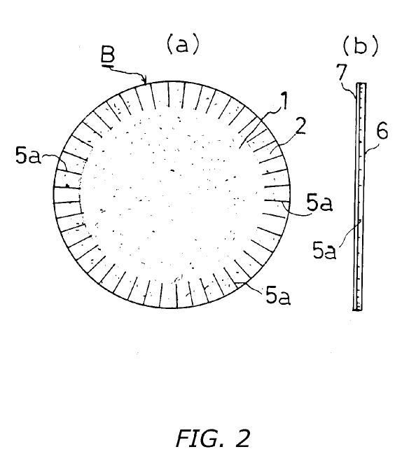

A circular plate 10 shown in FIG. 1 is obtained by forming a peripheral wall portion 2 that rises upward slanting outward from an circular bottom portion 1 and a rim 3 that extends substantially horizontally to the upper end of the peripheral wall portion 2, in a circular shape, and an extra rim 4 that is provided as an extension that slants downward on the outer diameter side from the tip of the rim portion 3. The vessel 10 is attained by compression molding a blank B (see FIG. 2) in which one or more sheets of a blank 7 made of thin paper, for example, are layered on a single sheet of a blank 6 made of thick paper, using a metal mold 20 for compression molding or the like that has been heated to approximately 160° C. Thus, the vessel is made of an upper vessel 16 and a lower vessel 17 that have been provided quasi-integrally. It should be noted that in the invention, the thick paper and the thin paper can be any paper quality, including paper whose surface has been processed, such as a silicon application paper, and can by a plastic film such as PET, polyethylene, polypropylene, polyvinylchloride, or other biodegradable resin films. The thickness of the thick paper and the thin paper is relative.

In this case, as shown in FIG. 2, wrinkle guide lines 5a that centripetally converge toward the center from the outer circumferential edge are pre-incised in advance in the thick paper-side blank 6 that has been cut into a predetermined shape. A single or a plurality of sheets of the blank 7, which are made of thin paper having the same shape as the blank 6, are stacked on the blank 6 in which these wrinkle guide lines 5a have been formed, forming a blank B. It is a feature of the invention that the wrinkle guide lines 5a serve as wrinkle troughs into which upper plied papers are tucked and pressed so that resistant entanglements are formed.

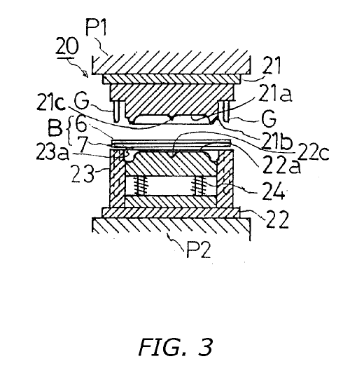

Illustrated in FIG. 3 is main portions of a typical compression molder equipped with a mold 20, wherein molder plates P1, P2 are installed, on P1 (upper) a cavity mold retainer plate 21 and a cavity mold 21a are mounted downwardly, and on P2 (lower) a core mold retainer plate 22 and a core mold 22a are also mounted upwardly so as to be opposed each other. The numbers 6, 7 (B, when merged) indicate a two plied blank which is going to be molded.

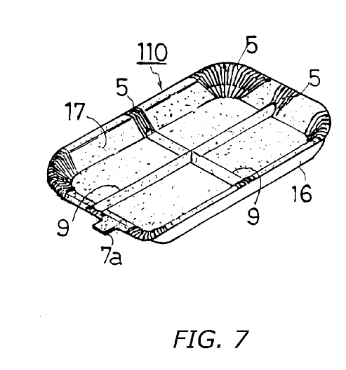

The cavity mold 21a and the core mold 22a are provided with mold faces shaped to be complementary to mold a designed product. Illustrated in FIG. 3 is a mold pair for molding a tray shown in FIG. 7. Therefore, readers are advised that the mold pair shown in FIG. 3 does not belong to Example 1, but to Example 2 as will be apparent later.

Then, frame 23 has cylindrical surface internally on which core mold 22a is allowed to slide vertically, wherein core mold 22a rests on a spring 24 during inoperative period. Further, frame 23 is provided with an inward projection 23a at its top end to form a slightly narrowed cylindrical contour so that core mold 22a will provide an exact engagement with cavity mold periphery 21b, by which engagement a sort of shearing knife will be formed. Thereby a freshly molded piece will be trimmed. Now, it is to be noted that in FIG. 3, the device numbered 23a is drawn only in left side, but it is for the purpose of simplicity and clarity of the drawing, and it may run the whole of the cylindrical circumference. Incidentally, G indicates a guide pin for controlling the molding operations.

The blanks 6(B) and 7(B) are inserted in between the cavity mold 21a and the core mold 22a, which oppose one another, of the metal mold 20, and by activating a press, the plate P1 on the cavity mold 21a side is moved forward and compresses the blank B. When the press continues to apply a pushing force, the core mold 21a overcomes the resilience of the spring 24 and retreats into the mold frame 23, and eventually the circumferential edge 22b of the cavity mold 21a fits into an inner diameter 23a of the front end of the mold frame and trims the molded blank B along the border of the vessel. Next, when the press stops applying pressure in order to cause the plate P1 to retreat, the core mold 21a returns to its original predetermined position within the mold frame 23 due to the repulsive force of the spring 24, ejecting the molded vessel. This vessel made of thick and thin paper blanks is laminated into one piece, and each vessel engaging one another through the wrinkle portion 5 as discussed above.

### WORKING EXAMPLE 1

The above is an overview of the working example 1 of the paper vessel according to the invention that is shown in FIGS. 1 and 2. The working example 1 is described in further detail below. In the circular plate 10, the blank 6 is cut from the thick paper taking into account the diameter corresponding to the bottom portion 1, the height of the rising side-wall portion 2, the edge portion 3, the extra rim 4, and also such that it is provided with the necessary area for trimming. Further, the wrinkle guide lines 5a (also referred to as folding markings) that centripetally converge from the circumferential portion of the blank 6 up to the rising side-wall portion 2 and the position in vicinity of the bottom periphery of the vessel are precut into the upper side of the blank 6.

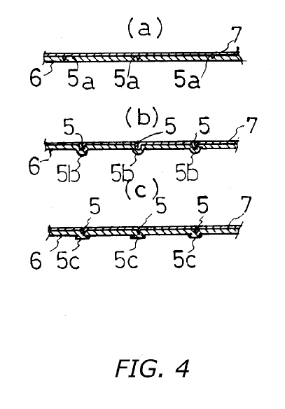

The act of heating the metal mold 20 (see FIG. 3) to about 160° C., furnishing it with the blank B that is obtained by laminating the thin-paper blank 7 on the thick-paper blank 6 of FIG. 2, both of which have substantially the same shape, and compression molding the blank B is discussed above. How the wrinkle guide line 5a portions will change through the molding is discussed with reference to FIG. 4. Centripetally converged wrinkles form in the sloped portion of the side walls, indicated by reference numeral 2. The rim 3 and the extra rim 4, which are further outward than the side walls 2, are formed by the pressure applied by the cavity mold.

FIG. 4 illustrates the vertical wrinkle portions 5 that occur in the rising side wall 2 and the edge 3. FIGS. 4A to 4C show how the manufacturing steps proceed. FIG. 4A illustrates the blank B that is obtained by layering the think-paper blank 7 on the thick-paper blank 6 in which the wrinkle guide lines 5a have been cut, and FIG. 4B illustrates the grooves 5b that are formed as the side wall portions rise upward, and simultaneously the portions to the left and right of the plurality of wrinkle guide lines 5a come together, when pressure is applied by the compression mold. The portions of the thin-paper blank 7 directly above the grooves 5b become wrinkles that are sandwiched within and engage the grooves 5b. As shown in FIG. 4C, when pressure is applied by the metal mold, the extruded portions that occur due to the grooves 5b are flattened somewhat. Due to these vertical wrinkles 5, the laminated vessels come to engage one another.

### WORKING EXAMPLE 2

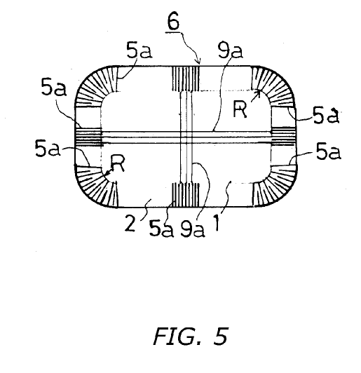

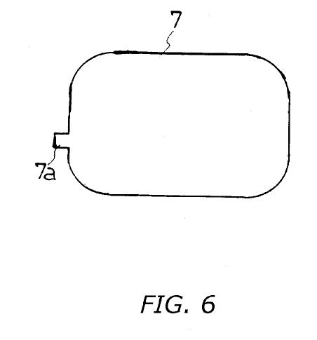

Working Example 2, wherein the vessel is referred to as a “tray,” is described with reference to FIGS. 5 to 7. FIG. 5 shows the blank 6, which is made of thick paper for molding an oblong tray 110 (see FIG. 6) in which angled ribs are formed in the bottom surface. Centripetally converged wrinkle guide lines 5a are provided in the four corners, and parallel wrinkle guide lines 5a are provided in substantially the center portions of the four sides of this oblong blank 6 from the edge of the blank to positions R that substantially correspond to the slanted surface 2 and the outer periphery of the vessel bottom surface. Also, cross-shaped ribs 9a are provided in a cross shape in the bottom surface 1 of the vessel. A single sheet or a plurality of sheets of a blank 7 (see FIG. 6) made of thin paper whose shape is substantially identical to that of the blank 6 (the folding lines are not necessary) is/are layered onto the blank 6, forming the blank B (not shown). It should be noted that reference numeral 7a denotes a tab for peeling the vessel made of thin paper from the main vessel unit.

The compression mold for compression molding the vessel using the above blank B is illustrated in FIG. 3. It is necessary to provide recessions/projections 21c and 22c in the cavity mold and the core mold in order to provide the cross-shaped ribs 9 in the center of the vessel. As shown in FIG. 7, the paper tray 110 that is obtained by molding the blank B with this metal mold has vertical wrinkles 5 formed not only in the four corners of the upper vessel 16 and the lower vessel 17 (shown speckled) but along in the center of the edges of their long and short sides, and this allows the laminated vessels to engage one another through the vertical wrinkle portions 5 as well. Further, rib guide lines are pre-incised in a cross shape in the blank 6 to form partitioning projections (see FIG. 7) in the center of the bottom surface of the vessel.

### WORKING EXAMPLE 3

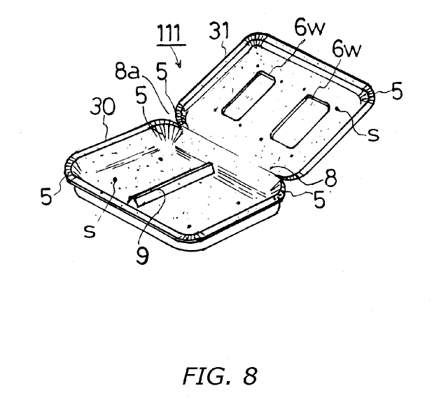

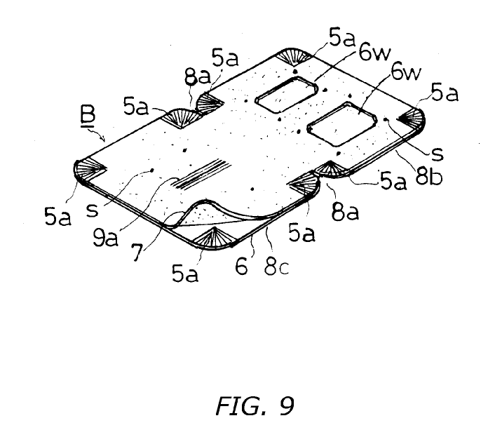

Working Example 3 is described with reference to FIGS. 8 to 10. In the paper vessel 111 shown in FIG. 8, a tray unit 30 and a lid member 31 that can open and close are connected through a hinge 8 and molded as one piece. Viewing windows 6w that are provided as openings in the lid member 31 are closed off by the upper vessel made of thin paper in such a manner that they can be seen through. As shown in FIG. 9, the blank B for molding this vessel is partitioned into a lid member side 8b and a main unit side 8c by forming notches 8a in both ends in substantially the center portion of two opposing edges of the thick paper 6 and the thin paper 7, that is, the portion where the hinge 8 is to be formed. The thick paper blank 6 is further provided with wrinkle guide lines 5a in the four corners of its lid member side and its main unit side, and if necessary, a rib guide line 9a for forming an angled rib (see FIG. 8), for example, is provided in the surface corresponding to the bottom portion of the main unit vessel.

It is obvious that the metal mold for molding the above vessel with lid (not shown) needs to be provided with a mold cavity and core that have recessions/projections (21a and 22a in FIG. 3) for forming the receptacle vessels 30 and the lid 31. In the vessel 111 (FIG. 8) formed by molding the above blank B with such a mold, the thick paper (lower) vessel and the thin paper (upper) vessel engage one another through the wrinkles 5 in their four corners. Consequently, the thin paper side can be peeled away in the same way as the laminated vessel discussed above to reveal a new vessel surface. Since products that are contained in the main vessel unit can be viewed through the windows 6w of the closed lid, this vessel can also be employed as a vessel for product display.

Above it was mentioned that a single or a plurality of thin paper blanks 7 are used for a single sheet of the thick paper blank 6, but it is also possible for a plastic film to be stacked on a single sheet of the thick paper blank and for the thin paper to be stacked on top of this film and the entire unit compression molded. As mentioned above, since the metal mold for compression molding is heated to around 160° C., the surface of the plastic film will melt when it comes into direct contact with the metal mold surface and the shriveling that occurs as it cools will result in a shriveled pattern in its surface, and this precludes a good surface from being obtained. However, by covering the plastic film with thin paper as discussed above, the plastic film does not come into direct contact with the metal mold and thus an attractive upper vessel can be formed. With this vessel, the thin paper surface is used before the plastic surface is used.

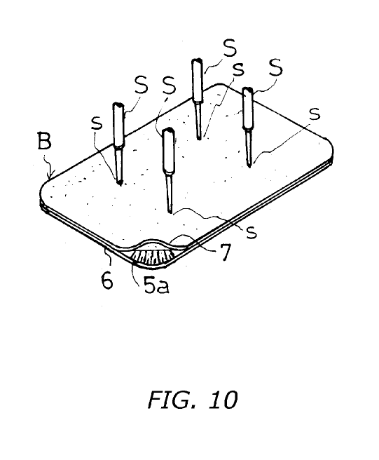

In the three working examples discussed above, a plurality of sheets of blanks 6 and 7 that have been cut to shape in advance are simply placed upon one another and in that state are supplied into the metal mold. The plurality of vessels that are formed in this manner engage one another through vertical wrinkle portions, as discussed above. With this layered blank B, however, there is a possibility that the blanks 6 and 7 will shift relative to one another when they are supplied into the metal mold. As shown in FIG. 10, one effective approach for preventing this is to bring a Horn for ultrasonic vibrational adhesion into contact with the rear surface of the plied blank in order to form spot adhesions through vibrational heating. In this case, it is not always possible to obtain a strong adhesive force through the ultrasonic vibrational adhesions S, but we found that the presence of lignin in the paper material allowed an adhesive strength that is sufficient for the vessel of the invention (strength that allows the thin paper side vessels to be peeled away one at a time when the vessel is used) to be obtained. The various operating conditions for adhesion through ultrasound are selected based on the paper quality, paper thickness, and number of sheets layered. Of course, it is also possible to adhere the blanks 6 and 7 by applying adhesive to the circumferential edge portions of the vessel that are discarded through trimming after the vessel has been molded. It should be noted that the “Horn” mentioned above is commercially available name.

### WORKING EXAMPLE 4

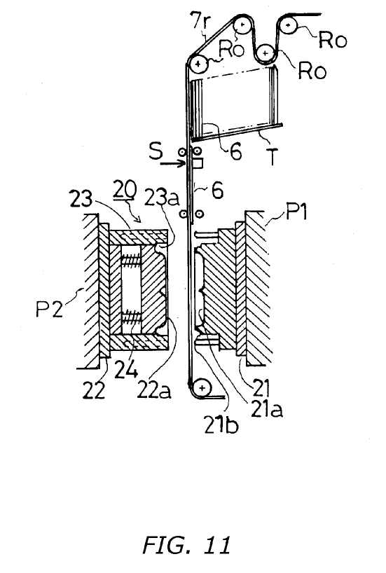

Working Example 4 is described with reference to FIG. 11. The above description is in reference to blanks 6 and 7 that have been cut to shape. Here, a method of compression molding a paper vessel directly using original paper in roll form rather than blanks that have been cut is described. FIG. 11 shows how a thick-paper blank 6 in a predetermined shape that has been provided with wrinkle guide lines 5a (not shown) at predetermined positions is supplied one sheet at a time from a stocking shelf T, for example, and attached to a predetermined position of an oblong thin paper 7r that is continuously supplied via rollers Ro, and this is introduced into the metal mold 20 for compression molding the vessel. In this case, it is of course preferable that the metal mold is provided with a suitable guide for setting the thick-paper blank 6 at the correct position within the mold.

The arrow directly above the metal mold 20 in FIG. 11 indicates a horn S that transmits the vibration from an ultrasonic vibrational heating device, which is not shown. Naturally, with this device it is preferable that the blank 6 made of thick paper is spot welded to a predetermined position of the oblong thin paper 7r, and further that the compression molding machine or the metal mold, for example, is furnished with a positioning sensor (not shown) so that the blank can be positioned correctly. The metal mold 20 for compression molding is essentially the same as that shown in FIG. 3, and the outer periphery of the oblong thin-paper blank 7r is trimmed at the same time that the vessel is formed due to the intimate fitting association between the front end edge portion 23a of the frame 23 and the outer circumferential edge 21b of the cavity of the metal mold 20.

### WORKING EXAMPLE 5

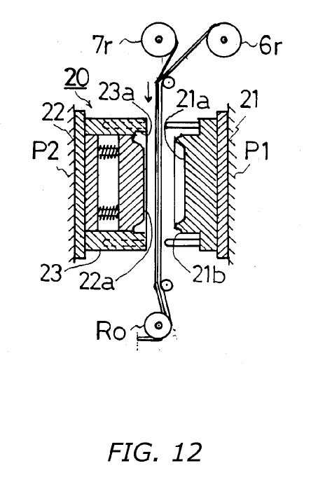

Working Example 5 is described with reference to FIG. 12. In the illustrative paper vessel molding device shown in FIG. 12, a roll-type original thick paper 6r serving as the material for the main vessel unit and a roll-type original thin paper 7r serving as the material for the upper vessel are both axially supported in manner that allows rotation, and the front ends of those original papers are passed between the core mold 21a and the cavity mold 21a of the metal mold 20 and wound around a roller with rotational driving device (not shown) via a roller Ro that is arranged below. Molding with this device requires either that wrinkle guide lines 5a are provided in predetermined positions of the thick original paper 6 in advance by a press device that is not shown or that a press device or the like (not shown) is arranged between the roll of original paper 6r and the metal mold 20 to form the wrinkle guide lines 5a. The original paper 6r in which wrinkle guide lines 5a have been provided is stacked on the original thin paper 7r, introduced into the mold, and then compression molded by the cavity mold 21a and the core mold 21a. The circumferential edge of the vessel is thus trimmed as discussed above, the molded vessel is discharged to outside the metal mold, and then the remaining original paper is recovered in a remaining-paper winding roller via the roller Ro below. The thick-paper side vessel and the thin-paper side vessel engage one another through the vertical wrinkles 5 that occur in the vessels as discussed previously.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A disposable paper eating utensil comprising:
a plurality of paper plies including
one bottom ply (6) being of a thick cellulose paper of sufficient durability to form a freestanding utensil, and
at least one upper ply (7) laminated over the bottom ply (6), said upper ply (7) lacking the durability to form a freestanding utensil; wherein
said upper ply (7) and said bottom ply (6) are made quasi-integral by being compressively joined through corrugations (5) produced by compression-molding of said plurality of paper plies substantially along corrugation guide lines (5a) provided on said upper ply (7).

2. A disposable paper eating utensil according to claim 1, wherein at least one rib is formed either protruding from or recessed into the utensil bottom.

3. A blank for a disposable paper eating utensil according to claim 1, wherein said upper ply is one selected from a thin cellulose paper, a silicon-coated paper, or a plastic film.

4. A blank for a disposable paper eating utensil according to claim 2, wherein said upper ply is one selected from a thin cellulose paper, a silicon-coated paper, or a plastic film.

5. A disposable paper eating utensil characterized by a main container section and a lid section integral via a hinge section, the utensil being molded from a blank obtained by laminating an inner ply made of thin paper onto an outer ply in which at least one open window is formed, the laminated plies being engaged together through vertical corrugations produced in the main container section and in the lid section.

6. A blank for a disposable paper eating utensil according to claim 3, wherein the laminated plies are separably spot adhered to one another.

7. A blank for a disposable paper eating utensil according to claim 4, wherein the laminated plies are separably spot adhered to one another.

8. A blank for a disposable paper eating utensil according to claim 5, wherein the laminated plies are separably spot adhered to one another.

9. A blank for a disposable paper eating utensil according to claim 1, wherein said upper ply is a continuous web fed between the cavity and core of a compression mold for molding paper eating utensils and the bottom ply is one of a plurality attached intermittently to the obverse or reverse surface the web.

10. A blank for a disposable paper eating utensil according to claim 2, wherein said upper ply is a continuous web fed between the cavity and core of a compression mold for molding paper eating utensils and the bottom ply is one of a plurality attached intermittently to the obverse or reverse surface the web.

11. A blank for a disposable paper eating utensil according to claim 6, wherein the laminated plies are ultrasonically spot welded to one another in a number of locations.

12. A blank for a disposable paper eating utensil according to claim 7, wherein the laminated plies are ultrasonically spot welded to one another in a number of locations.

13. A blank for a disposable paper eating utensil according to claim 8, wherein the laminated plies are ultrasonically spot welded to one another in a number of locations.

14. A blank for a disposable paper eating utensil according to claim 9, wherein the laminated plies are ultrasonically spot welded to one another in a number of locations.

15. A blank for a disposable paper eating utensil according to claim 10, wherein the laminated plies are ultrasonically spot welded to one another in a number of locations.

16. A mold for manufacturing a paper container, comprising:
a cavity on the retainer plate in one side of the mold, said cavity formed in the shape of the container, following its rising sidewall surfaces;
a core on the retainer plate in the other side of the mold, said core formed in the same shape as said cavity and, across a gap equal to a two- to three-ply blank, symmetrical with respect to said cavity; wherein
along a portion of the cavity corresponding to the container outer rim, the cavity-side retainer plate and the core-side retainer plate are configured either to abut on each other circumferentially, or to fit into each other to form shearing blade surfaces, for trimming the container rim at the same time the container is formed.
